(19) United States
(12) Patent Application Publication
(10) Pub. No.: US 2017/0225118 A1
(43) Pub. Date: Aug. 10, 2017

(54) CARBON DIOXIDE ABSORBENT COMPRISING OXYGEN-CONTAINING DIAMINE

(71) Applicant: UNIVERSITY-INDUSTRY COOPERATION GROUP OF KYUNG HEE UNIVERSITY, Yongin-si, Gyeonggi-do (KR)

(72) Inventors: Heehwan KIM, Seoul (KR); Hoon Sik KIM, Seoul (KR)

(73) Assignee: UNIVERSITY-INDUSTRY COOPERATION GROUP OF KYUNG HEE UNIVERSITY, Yongin-si, Gyeonggi-do (KR)

(21) Appl. No.: 15/519,374

(22) PCT Filed: Oct. 16, 2015
(86) PCT No.: PCT/KR2015/010938

§ 371 Date: Apr. 14, 2017

(30) Foreign Application Priority Data
Oct. 16, 2014 (KR) 10-2014-0139982

(51) Int. Cl. B01D 53/14

(52) U.S. Cl. CPC B01D 53/1493; B01D 53/1475; B01D 2252/2041; B01D 2252/20431; B01D 2252/20447; B01D 2252/103; B01D 2252/504

(57) ABSTRACT

The present invention relates to a carbon dioxide absorbent comprising an oxygen-containing diamine, a cyclodiamine and a polyalkylene glycol dialkyl ether. The carbon dioxide absorbent according to the present invention can improve the carbon dioxide absorption capacity, absorption rate and regeneration performance thereof simultaneously by using the oxygen-containing diamine as a main absorbent, the cylodiamine as a rate enhancer, and the polyalkylene glycol dialkyl ether as a fine disproportionation agent and a regeneration promoter.

### TECHNICAL FIELD

The present invention relates to a carbon dioxide absorbent comprising an oxygen-containing diamine, a cyclodiamine and a polyalkylene glycol dialkyl ether. More specifically, the present invention relates to an amine-based carbon dioxide absorbent which is excellent in carbon dioxide absorption capacity, absorption rate and regeneration performance.

### BACKGROUND OF ART

In general, an absorption method, an adsorption method, a membrane separation method, a cryogenic cooling method and the like are used to separate carbon dioxide (CO₂) from the exhaust gas of chemical plants, power plants or large-sized boilers and from natural gas. In particular, an absorption or adsorption method is widely used when the concentration of exhausted carbon dioxide is low.

The absorption or adsorption method is widely used since it can selectively separate only some gases that are well absorbed or adsorbed by an absorbent or adsorbent; however, there is a disadvantage that, since the absorbent or adsorbent is chemically altered during the separation process, it is necessary to periodically replace the absorbent or adsorbent. Therefore, in the case of using a solid adsorbent, the chemical alteration of the adsorbent is reduced, and thus it is advantageous for the adsorbent to be applied only when the adsorbent replacement cycle is long. On the other hand, since the absorption method uses a liquid absorbent and thus the absorbent is easy to replace and has a greater absorption capacity than that of the adsorbent, it is widely used in purification of a large amount of exhaust gas or used in gas separation; however, there is still a disadvantage that the liquid absorbent is chemically or thermally altered.

As carbon dioxide absorbents, aqueous solutions containing amines such as monoethanolamine (MEA), diethanolamine (DEA), piperazine or the like are widely used in industry. This is because these amine-based absorbents react with carbon dioxide to easily form stable carbamate compounds, and the carbamate compounds can be decomposed again into carbon dioxide and amine when heat is applied. However, the process for capturing carbon dioxide using these amine-based absorbents has several serious problems. In particular, due to high thermal and chemical stability of carbamate formed by reaction with carbon dioxide, the decomposition temperature is as high as 120° C. or more, thereby causing excessive regeneration energy consumption (MEA requires 4.0 to 4.2 GJ per ton of carbon dioxide), excessive volatile loss of amine due to the high regeneration temperature (4 kg per ton in the case of using MEA), and replenishment of an absorbent.

In order to resolve the drawbacks of the amine-based aqueous solution absorbents, there have been reported various methods of physically absorbing carbon dioxide using organic solvents such as Selexol, IFPexol, NFM, etc. One important advantage of the organic solvent absorbent is that much lower energy is required to recover carbon dioxide and recycle solvents since the absorption of carbon dioxide is achieved only by a physical interaction between the absorption solvent and carbon dioxide, not by the chemical bond as in the case of the aqueous amine absorbents. Actually, in the case of using the amine absorbent, the recovery of carbon dioxide and the recycling of the absorbent require an energy-intensive, high-temperature separating process; however, in the case of the physical absorption, it is possible to recover carbon dioxide dissolved in the solvent by simply changing the pressure, without increasing the temperature. However, the physical absorption process has the following drawbacks.

First, low carbon dioxide absorption capacity: Organic solvents generally exhibit a carbon dioxide absorption capacity at normal pressure that is significantly lower than that of an aqueous amine solution, such that the circulation rate of the absorbent is high, thus requiring relatively large equipment. Therefore, the organic solvent absorbent is more suitable for natural gas purification in which the pressure of carbon dioxide is high.

Second, high circulation rate: Physical absorption process by organic solvents typically requires twice higher absorbent circulation rate compared to amine solutions, thereby requiring more capital and equipment costs.

Therefore, there is a need for the development of a novel absorbent that has high thermal and chemical stability, and has low vapor pressure, so as to overcome the drawbacks of the amine absorbent and the organic solvent absorbent.

Recently, as a method for overcoming the drawbacks of conventional absorbents, attempts have been made to utilize, as an absorbent, an ionic liquid that is non-volatile, has high thermal stability and maintains a liquid phase at a low temperature of 100° C. or less, as disclosed in U.S. Pat. No. 6,849,774, U.S. Pat. No. 6,623,659 and US Patent Application Publication No. 2008/0146849. However, in order to synthesize these ionic liquids, not only complicated manufacturing steps of two or more steps are required but also the manufacturing cost is too high, so that there are many problems in industrial application. In addition, the physical absorbents such as organic solvents and ionic liquids are not suitable for capturing carbon dioxide from the exhaust gas discharged at atmospheric pressure after combustion because of their low ability to absorb carbon dioxide at low pressure.

Therefore, in order to capture carbon dioxide from the exhaust gas after combustion, a chemical absorbent must be always used. However, as mentioned above, the alkanolamine-based chemical absorbent such as MEA has several drawbacks; in particular, there is a problem that excessive regeneration energy is consumed. Recently, attempts have been made to reduce regeneration energy of chemical absorbents, including a method of using, as an absorbent, alkanolamine sterically hindered around amine groups, and a typical example thereof is 2-amino-2-methyl-1-propanol (AMP) which is a primary amine. When reacting with carbon dioxide, AMP forms bicarbonate compounds ([AMPH][HCO₃]) that may be regenerated more readily than carbamates, thereby requiring 30% less regeneration energy compared to MEA; however, its CO₂ absorption rate is less than 50% of the absorption rate of MEA.

As a method of increasing the absorption rate of AMP, Mitsubishi Heavy Industries, Ltd. and Kansai Electric Power Co., Inc. made a joint effort to develop a novel absorbent prepared by adding piperazine, which is a secondary cycloamine, to AMP (Japanese Patent No. 3197173). However, the absorbent disclosed in this patent has a problem in that precipitation occurs in the process of absorption of carbon dioxide, and when piperazine is reacted with carbon dioxide, thermally stable carbamate compounds are formed in addition to bicarbonates, such that a regeneration process is difficult to perform.

Further, there is also known a method of using, as a carbon dioxide absorbent, alkali carbonate, such as sodium carbonate or potassium carbonate, instead of using a primary alkanolamine absorbent; however, the method has a problem of low carbon dioxide absorption rate. As a method of increasing a carbon dioxide absorption rate, WO 2004/089512 A1 discloses that when piperazine or its derivative is added to potassium carbonate, a carbon dioxide absorption rate is significantly increased; however, this method has a problem such as the formation of precipitate in the process of using potassium carbonate.

### DETAILED DESCRIPTION OF THE INVENTION

### Technical Problem

Based on the fact that primary and secondary amines having high carbon dioxide absorption rate react with carbon dioxide to mainly form ionic carbamate compounds, and these carbamate compounds are further stabilized in solvents with high polarity such as water and thus are not easily decomposed even at a temperature of 100° C. or higher, the present inventors have conducted tests to reduce the polarity of the solution by adding various organic solvents to the amine aqueous solution, so as to facilitate the decomposition of the carbamate. As a result, the inventors have found that, when polyalkylene glycol dialkyl ether having less water solubility is present in an amine aqueous solution, the polarity of the aqueous solution is lowered, a fine disproportionation occurs in the aqueous solution, and the stability of the carbamate is remarkably lowered, thereby facilitating the regeneration of the amine. The present invention has been completed on the basis of such finding.

Therefore, an object of the present invention is to provide a carbon dioxide absorbent which is excellent in carbon dioxide absorption capacity, absorption rate and regeneration performance.

Another object of the present invention is to provide a method for separating carbon dioxide from a gas mixture using the carbon dioxide absorbent.

### Technical Solution

In order to achieve the objects, the present invention provides a carbon dioxide absorbent comprising: an oxygen-containing diamine represented by the following chemical formula 1, a cyclodiamine represented by the following chemical formula 2 and a polyalkylene glycol dialkyl ether represented by the following chemical formula 3:

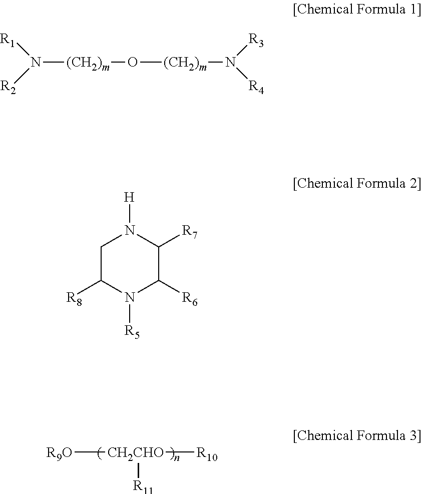

wherein,

R₁, R₂ and R₃ are each independently a C₁-C₄ alkyl group, preferably methyl, ethyl, propyl or butyl,

R₄ is hydrogen or a C₁-C₄ alkyl group, preferably hydrogen, methyl, ethyl, propyl or butyl,

R₅ is hydrogen, a C₁-C₄ alkyl group or a C₁-C₄ aminoalkyl group, preferably hydrogen, methyl, ethyl, propyl, butyl or aminoethyl,

R₆ is hydrogen or a C₁-C₄ alkyl group, preferably hydrogen or methyl,

R₇ and R₈ are each independently hydrogen or a C₁-C₄ alkyl group, preferably hydrogen or methyl,

R₉ and R₁₀ are each independently a C₁-C₄ alkyl group, preferably methyl, ethyl, propyl or butyl,

R₁₁ is hydrogen or methyl,

m is an integer of 2 or 3, and

n is an integer of 2 to 4.

As used herein, the C₁-C₄ alkyl group refers to a linear or branched hydrocarbon group having 1 to 4 carbon atoms, and includes, for example, methyl, ethyl, n-propyl, i-propyl, n-butyl, i-butyl, t-butyl or the like, but is not limited thereto.

As used herein, the C₁-C₄ aminoalkyl group refers to a linear or branched hydrocarbon group having 1 to 4 carbon atoms substituted with an amino group, and includes, for example, aminomethyl, aminoethyl, aminopropyl or the like, but is not limited thereto.

The oxygen-containing diamine represented by the chemical formula 1 includes, for example, 2,2′-oxybis(N,N-dimethylethylamine) (BDMAE), 2,2′-oxybis(N,N-diethylethylamine)(BDEEA), 2,2′-oxybis(N, N-dipropylethylamine) (BDPEA), 2,2′-oxybis(N,N-dibutylethylamine) (BDBEA), 2,2′-oxybis(N,N-dimethylpropylamine) (BDMPA), 2,2′-oxybis(N,N-diethylpropylamine) (BDEPA), 2,2′-oxybis(N,N-dipropylpropylamine) (BDPPA), 2,2′-oxybis(N,N-dibutylpropylamine) (BDBPA), {2-[2-(dimethylamino)ethoxy]ethyl}methylamine (DMEEMA), {2-[2-(diethylamino)ethoxy]ethyl}ethylamine (DMEEEA), {2-[2-(diethylamino)ethoxy]ethyl}methylamine (DEEEMA), {2-[2-(dipropylamino)ethoxy]ethyl}propylamine (DPEEPA), {2-[2-(dibutylamino)ethoxy]ethyl}butylamine (DBEEBA), {3-[3-(dimethylamino)propoxy]propyl}methylamine (DMPPMA), {3-[3-(diethylamino)propoxy]propyl}ethylamine (DEPPEA), {3-[3-(diethylamino)propoxy]propyl}methylamine (DEPPMA), {2-[2-(dipropylamino)propoxy]propyl}propylamine (DPPPPA), {2-[2-(dibutylamino)propoxy]propyl}butylamine (DBPPBA) and the like, but is not limited thereto.

The cyclodiamine represented by the chemical formula 2 includes, for example, piperazine (PZ), 1-methylpiperazine (1-MPZ), 1-ethylpiperazine (1-EPZ), 1-propylpiperazine (1-PPZ), 1-isopropylpiperazine (1-IPPZ), 1-butylpiperazine (1-BPZ), 2-methylpiperazine (2-MPZ), 1,2-dimethylpiperazine (1,2-DMPZ), 1,5-dimethylpiperazine (1,5-DMPZ), 1,6-dimethylpiperazine (1,6-DMPZ), N-(2-aminoethyl)piperazine (AEPZ) and the like, but is not limited thereto.

The polyalkylene glycol dialkyl ether represented by the chemical formula 3 includes, for example, diethylene glycol dimethyl ether, diethylene glycol diethyl ether, diethylene glycol ethyl methyl ether, diethylene glycol dipropyl ether, diethylene glycol dibutyl ether, dipropylene glycol dimethyl ether, dipropylene glycol diethyl ether, dipropylene glycol ethyl methyl ether, dipropylene glycol dipropyl ether, dipropylene glycol dibutyl ether, triethylene glycol dimethyl ether, triethylene glycol diethyl ether, triethylene glycol dipropyl ether, triethylene glycol dibutyl ether, tripropylene glycol dimethyl ether, tripropylene glycol diethyl ether, tripropylene glycol dipropyl ether, tripropylene glycol dibutyl ether, tetraethylene glycol dimethyl ether, tetraethylene glycol diethyl ether, tetraethylene glycol ethyl methyl ether, tetraethylene glycol dipropyl ether, tetraethylene glycol dibutyl ether, tetrapropylene glycol dimethyl ether, tetrapropylene glycol diethyl ether, tetrapropylene glycol ethyl methyl ether, tetrapropylene glycol dipropyl ether and tetrapropylene glycol dibutyl ether, but is not limited thereto.

The amount of the oxygen-containing diamine may be 10 to 70% by weight, preferably 20 to 50% by weight, based on the total amount of the absorbent, considering the absorption capacity and absorption rate of carbon dioxide, and the viscosity of the absorbent. If the amount of the oxygen-containing diamine is less than 10% by weight, the absorption rate and absorption capacity of carbon dioxide is lowered, and if it exceeds 70% by weight, the viscosity of the absorber solution increases, which causes a problem that the carbon dioxide absorption rate decreases and the absorbent transport becomes difficult.

The amount of the cyclodiamine may be 1 to 30% by weight, preferably 5 to 20% by weight, based on the total amount of the absorbent. If the amount of the cyclodiamine is less than 1% by weight, the effect of increasing the carbon dioxide absorption rate is insignificant. If the amount of the cyclodiamine is more than 30% by weight, there is a problem that energy consumption increases during the regeneration, while an increase in the carbon dioxide absorption rate is insignificant.

The amount of polyalkylene glycol dialkyl ether is 5 to 40% by weight, preferably 10 to 30% by weight, based on the total amount of the absorbent. The amount of polyalkylene glycol dialkyl ether to be used varies slightly depending on the solubility in water, but in general, if the amount is less than 5% by weight of the total amount of the absorbent, the disproportionation phenomenon is weak and thus the regeneration effect of the absorbent decreases. If the amount exceeds 40% by weight, the regenerating effect of the carbon dioxide absorbent increases, but the viscosity of the absorbent becomes high and the concentration of amine becomes low. Thus, there is a problem that carbon dioxide absorption amount and absorption rate are lowered.

The carbon dioxide absorbent of the present invention comprising oxygen-containing diamines, cyclodiamines and polyalkylene glycol dialkyl ethers can absorb carbon dioxide even in the absence of a solvent, but in consideration of the viscosity of the absorbent, it is desirable to use it in the state of an aqueous solution, that is, by dissolving the carbon dioxide absorbent in water.

The amount of water in the absorbent is 10 to 70% by weight, preferably 20 to 50% by weight, based on the total amount of the absorbent. If the amount of water is less than 10% by weight, the viscosity of the absorbent solution becomes high, so that the absorption rate of carbon dioxide and the regeneration capacity of the absorbent are significantly lowered, whereas when it exceeds 70% by weight, the viscosity of the absorbent is lowered, but there is a problem that the carbon dioxide absorption capacity is lowered.

The carbon dioxide absorbent according to the present invention can improve the carbon dioxide absorption capacity, absorption rate and regeneration performance thereof simultaneously by using an oxygen-containing diamine as a main absorbent, a cyclodiamine as a rate enhancer, and a polyalkylene glycol dialkyl ether as a fine disproportionation agent and a regeneration promoter.

Among the constituents of the carbon dioxide absorbent according to the present invention, the oxygen-containing diamine, which is the main absorbent, has excellent carbon dioxide absorption capacity and regeneration performance, but there is a disadvantage that the absorption rate is low. The cyclodiamine, which is a rate enhancer, has high absorption rate, but it mainly generates an ionic carbamate compound having high thermal stability when reacted with carbon dioxide, which makes it difficult to regenerate. However, in the case where a polyalkylene glycol dialkyl ether is present in the carbon dioxide absorbent component, the fine disproportionation occurs in the absorbent solution due to the interaction between the oxygen-containing diamine, cyclodiamine, polyalkylene glycol dialkyl ether and water, and therefore strong hydrogen bonding between the carbamate and water is weakened. As a result, the stability of the carbamate is lowered and the regeneration of the absorbent is facilitated.

Therefore, when the absorbent according to the present invention is used, not only the absorbent can be regenerated even at a low temperature compared with a conventional absorbent, but also the absorption capacity of carbon dioxide per unit volume of the absorbent can be maintained at a remarkably high level, and thus the energy of the overall absorption process can be drastically reduced and the problem of corrosion and absorbent loss derived from the high regeneration temperature can also be greatly reduced.

On the other hand, the present invention relates to a method for separating carbon dioxide from a gas mixture using the carbon dioxide absorbent according to the present invention. The separation method of the present invention comprises the steps of:

(i) absorbing carbon dioxide by using a carbon dioxide absorbent including an oxygen-containing diamine represented by the chemical formula 1, a cyclodiamine represented by the chemical formula 2, and a polyalkylene glycol dialkyl ether represented by the chemical formula 3; and

(ii) separating the absorbed carbon dioxide from the carbon dioxide absorbent.

Examples of the gas mixture may include exhaust gases that are discharged from chemical plants, power plants, ironworks, cement plants and large boilers, natural gases and the like.

When carbon dioxide is absorbed in step (i), the absorption temperature may be preferably in the range of 10° C. to 60° C., and more preferably in the range of 30° C. to 50° C.; and the absorption pressure may be preferably in the range of normal pressure to 30 atm, and more preferably in the range of normal pressure to 10 atm. In the case where the absorption temperature is above 60° C., separation of carbon dioxide is performed at the same time as the absorption such that the absorbed amount of carbon dioxide is reduced, whereas in the case where the absorption temperature is below 10° C., additional refrigeration equipment is required to lower the temperature, thereby causing economic inefficiency. Further, an exhaust gas has normal pressure, such that it is most economical to perform absorption at normal pressure. In the case where an absorption pressure is above 30 atm, although an absorption amount is greatly increased, additional equipment, i.e., a compressor, is needed to increase the pressure, thereby resulting in economic inefficiency.

When the absorbed carbon dioxide is separated in step (ii), the temperature may be preferably in the range of 70° C. to 140° C., and more preferably in the range of 80° C. to 120° C., and the separation pressure may be preferably in the range of normal pressure to 2 atm. In the case where the separation temperature is less than 70° C., the separation amount of carbon dioxide is greatly reduced, whereas in the case where the separation temperature is more than 140° C., not only the amount that the absorbent is evaporated and lost is increased but also the condition is the same as in the case of using monoethanolamine (MEA) as an absorbent, such that the advantages of the fine disproportionation absorber according to the present invention disappear. Further, it is difficult to perform separation at a high pressure of 2 atm or more, since a vapor pressure of water is required to be significantly increased to maintain such high pressure, thereby requiring high temperature and resulting in economic inefficiency.

Among the terms used throughout the present invention, the term “normal pressure” refers to atmospheric pressure, i.e., 1 atm.

### Advantageous Effects

The carbon dioxide absorbent according to the present invention has high carbon dioxide absorption capacity and a high absorption rate, and has a high absorbent regeneration performance even at a low temperature as compared to prior absorbents, thereby significantly reducing the entire energy consumption, and it is possible to prevent the recovered carbon dioxide from being contaminated with the moisture and the absorbent vapor due to the low regeneration temperature. Moreover, even when absorption and separation of carbon dioxide are repeated, almost all of the initial absorption capacity can be maintained and thus it can be used as an excellent carbon dioxide separation medium.

### BRIEF DESCRIPTION OF DRAWING

FIG. 1 is a schematic view illustrating an example of a device for carbon dioxide absorption and separation tests.

### DETAILED DESCRIPTION OF THE EMBODIMENTS

Hereinafter, the invention is described more fully with reference to illustrative embodiments and the accompanying drawings. However, it would be obvious to those skilled in the art that the embodiments are merely illustrative for explanation of the present invention, and the scope of the present invention is not limited thereto.

Device and Process for Carbon Dioxide Absorption Tests

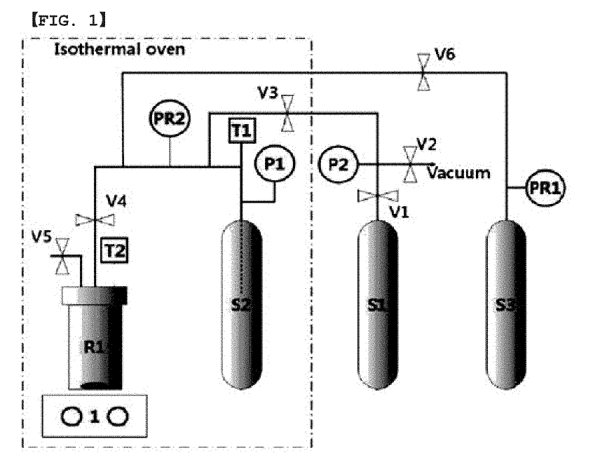

Tests on the carbon dioxide absorption capacity were conducted by using the device illustrated in FIG. 1. The device illustrated in FIG. 1 includes a 60 ml stainless steel absorption reactor R1 equipped with a thermometer T2, a pressure transducer for high pressure (0 to 70 atm) P1, a 75 ml carbon dioxide storage cylinder S2 equipped with a thermometer T1, and a stirrer 1, and is installed in an isothermal oven to measure the carbon dioxide absorption capacity at a constant temperature. Further, a carbon dioxide supply cylinder S1 and a manometer P2 are installed on the outside of the isothermal oven.

After weighing the entire weight of the absorption reactor R1 into which a certain amount of absorbent was put along with a magnet bar, the absorption reactor was stirred at 60° C. for one hour to be dried under vacuum, and then the temperature was reduced to 40° C. so that the absorption reactor and the isothermal oven were maintained at a constant temperature. After closing a valve V4 connected to the absorption reactor R1, carbon dioxide at a constant pressure (e.g., 10 to 50 atm) was put into the storage cylinder S2, and the pressure and temperature in equilibrium were recorded. Then, after the stirring of the absorption reactor R1 was stopped and the pressure of the absorption reactor R1 was maintained at a constant pressure by using the valve V4 and a pressure regulator, the pressure and temperature of the storage cylinder S2 in equilibrium were recorded, and then the stirring was started. After one hour, the final pressure and temperature (equilibrium values) were recorded, and a change in the weight of the absorption reactor R1 was measured.

Further, during a separation test, after closing the valve V4 and increasing the temperature of the absorption reactor R1 to 70° C. to 140° C., the valve V4, a valve V5 and a valve V6 were opened, and 20 ml/min of nitrogen was introduced to the absorption reactor R1 to separate carbon dioxide. Then, the temperature was reduced to room temperature, and a change in the weight before and after the separation was measured.

### Examples 1 to 9

30 g of an aqueous solution absorbent having a weight ratio of oxygen-containing diamine/cyclodiamine/polyalkylene glycol dialkyl ether/water of 30/5/15/50 shown in Table 1 below was added to the absorption reactor R1 illustrated in FIG. 1, and then carbon dioxide absorption tests were performed while maintaining the temperature of the isothermal oven at 40° C. After stirring of the absorption reactor R1 was stopped, the pressure of the absorption reactor R1 was maintained at 1 atm by using the valve V4 and a pressure regulator, and the pressure of the storage cylinder S2 maintained in equilibrium was recorded, and then the stirring was started again. After one hour, the final pressure was recorded, and the amount of carbon dioxide absorbed per mole of amine was calculated from the difference.

In the case of the separation and carbon dioxide reabsorption tests, after closing the valve (V4) and raising the temperature of the absorption reactor (R1) to 100° C., the valve (V4), the valve (V5) and the valve (V6) were opened, and carbon dioxide was separated for 1 hour while introducing 20 ml/min of nitrogen to the absorption reactor (R1), and then the tests of reabsorbing carbon dioxide at 40° C. were carried out. Further, in order to ensure the accuracy of the measurement, the weight change of the absorption reactor (R1) was measured before and after absorption and separation tests, and the results are shown in Table 1 below as the cyclic capacity (mole number of carbon dioxide absorbed per mole of amine at the time of reabsorbing carbon dioxide after separation).

TABLE 1

| | | | | CO₂ | |
|---|---|---|---|---|---|
| | | | | absorption | Cyclic |
| | Absorbent components | | | capacity | capacity |
| | oxygen- | | Polyalkylene | (mole of | (mole of |
| | containing | Cyclo- | glycol | CO₂/mole | CO₂/mole |
| Example | diamine | diamine | dialkyl ether | of amine | of amine) |
| 1 | BDMAE | PZ | diethylene | 1.23 | 1.18 |
| | | | glycol | | |
| | | | diethyl ether | | |
| 2 | BDEEA | 1-MPZ | diethylene | 1.32 | 1.21 |
| | | | glycol | | |
| | | | dimethyl ether | | |
| 3 | BDBEA | 1-BPZ | dipropylene | 1.28 | 1.22 |
| | | | glycol | | |
| | | | dimethyl ether | | |
| 4 | BDMPA | 2-MPZ | triethylene | 1.27 | 1.15 |
| | | | glycol | | |
| | | | dimethyl ether | | |
| 5 | BDPPA | 1,2- | diethylene | 1.21 | 1.16 |
| | | DMPZ | glycol | | |
| | | | dibutyl ether | | |
| 6 | DPEEPA | 1,5- | tripropylene | 1.17 | 1.11 |
| | | DMPZ | glycol | | |
| | | | dipropyl ether | | |
| 7 | BDMAE | AEPZ | diethylene | 1.26 | 1.05 |
| | | | glycol ethyl | | |
| | | | metyl ether | | |
| 8 | BDEEA | PZ | Tetraethylene | 1.35 | 1.12 |
| | | | glycol | | |
| | | | dimethyl ether | | |
| 9 | DEEEMA | 2-MPZ | Tetrapropylene | 1.36 | 1.19 |
| | | | glycol | | |
| | | | diethyl ether | | |

### Examples 10 to 13

Carbon dioxide absorption tests were carried out in the same manner as in Example 1: by using an absorbent having the same composition as in Example 1; and by varying the absorption temperature while fixing the carbon dioxide pressure at 1 atm. The results are shown in Table 2 below.

TABLE 2

| | Absorption | CO₂ absorption | Cyclic capacity |
|---|---|---|---|
| | temperature | capacity (mole of | (mole of CO₂/mole |
| Example | (° C.) | CO₂/mole of amine) | of amine) |
| 10 | 10 | 1.35 | 1.24 |
| 11 | 30 | 1.31 | 1.22 |
| 12 | 50 | 1.11 | 1.00 |
| 13 | 60 | 0.88 | 0.81 |

### Examples 14 to 17

Carbon dioxide absorption tests were carried out in the same manner as in Example 1: by using an absorbent having the same composition as in Example 1; and by varying the absorption pressure while fixing the temperature at 40° C. The results are shown in Table 3 below.

TABLE 3

| | | CO₂ Absorption | |
|---|---|---|---|
| | | capacity (mole of | Cyclic capacity |
| | Absorption | CO₂/mole | (mole of CO₂/mole |
| Example | pressure (atm) | of amine) | of amine) |
| 14 | 2 | 1.31 | 1.25 |
| 15 | 5 | 1.45 | 1.31 |
| 16 | 10 | 1.56 | 1.49 |
| 17 | 30 | 1.78 | 1.65 |

### Examples 18 to 21

Carbon dioxide absorption tests were carried out in the same manner as in Example 1: by changing the amount of water while fixing weight % of oxygen-containing diamine/cyclodiamine/polyalkylene glycol dialkyl ether/water at 60/10/30, the temperature at 40° C. and the pressure at 1 atm. The results are shown in Table 4 below. As the amount of water was decreased, the amount of carbon dioxide absorbed per mole of amine was reduced. The reason for this is considered that an increased amount of amine leads to an increase in the viscosity of an absorbent solution, thereby limiting delivery of materials.

TABLE 4

| | | CO₂ absorption | Cyclic capacity |
|---|---|---|---|
| | Content of | capacity (mole of | (mole of CO₂/mole |
| Example | water (wt %) | CO₂/mole of amine) | of amine) |
| 18 | 10 | 1.03 | 0.94 |
| 19 | 30 | 1.19 | 1.08 |
| 20 | 60 | 1.28 | 1.21 |
| 21 | 70 | 1.33 | 1.27 |

### Examples 22 to 30

Carbon dioxide absorption tests were carried out in the same manner as in Example 1: by varying the composition (weight %) of oxygen-containing diamine (A) as a main absorbent, cyclodiamine (B) as a rate enhancer and diethylene glycol diethyl ether (C) as a fine disproportionation agent while fixing the amount of water in the absorbent at 50 weight %, the absorption temperature at 40° C. and the absorption pressure at 1 atm. The results are shown in Table 5 below.

TABLE 5

| | | | | CO₂ | |
|---|---|---|---|---|---|
| | | | | absorption | Cyclic |
| | | | | capacity | capacity |
| | | | | (mole of | (mole of |
| | Absorbent Composition (wt %) | | | CO₂/mole | CO₂/mole |
| Example | A | B | C | of amine) | of amine) |
| 22 | 40 | 5 | 5 | 1.41 | 1.36 |
| 23 | 30 | 10 | 10 | 1.31 | 1.16 |
| 24 | 30 | 3 | 17 | 1.28 | 1.25 |
| 25 | 30 | 15 | 5 | 1.24 | 1.01 |
| 26 | 25 | 1 | 24 | 1.38 | 1.29 |
| 27 | 25 | 5 | 20 | 1.15 | 1.09 |
| 28 | 25 | 10 | 15 | 1.13 | 1.01 |
| 29 | 10 | 30 | 10 | 1.10 | 0.98 |
| 30 | 14 | 1 | 35 | 1.45 | 1.42 |

### Examples 31 to 39

Changes in cyclic capacity according to changes in the separation temperature and pressure were measured while fixing the composition of the absorbent and the absorption temperature (40° C.) in Example 1. The results are shown in Table 6 below.

TABLE 6

| | | | CO₂ absorption | Cyclic |
|---|---|---|---|---|
| | Separation | Separation | capacity (mole | capacity (mole |
| | temperature | pressure | of CO₂/mole | of CO₂/mole |
| Example | (° C.) | (atm) | of amine) | of amine) |
| 31 | 70 | 1 | 1.23 | 0.88 |
| 32 | 80 | 1 | 1.23 | 0.97 |
| 33 | 90 | 1 | 1.23 | 1.11 |
| 34 | 100 | 2 | 1.23 | 1.20 |
| 35 | 110 | 1 | 1.23 | 1.22 |
| 36 | 110 | 2 | 1.23 | 1.23 |
| 37 | 120 | 1 | 1.23 | 1.23 |
| 38 | 130 | 1 | 1.23 | 1.23 |
| 39 | 140 | 1 | 1.23 | 1.23 |

### Comparative Example 1

The separation test was performed in the same manner as in Example 1 by absorbing carbon dioxide at 1 atm and 40° C. by using an aqueous solution containing 50% by weight of monoethanolamine as an absorbent, and separating the absorbed carbon dioxide at normal pressure and 100° C. As a result, the carbon dioxide absorption capacity was 0.55 mol of carbon dioxide per mole of monoethanolamine; however, when carbon dioxide was reabsorbed after separation at 100° C., the cyclic capacity was confirmed that carbon dioxide was absorbed only by 0.19 mol per 1 mol of monoethanolamine and the absorption capacity of the monoethanolamine aqueous solution was reduced by about 65.5%.

### DESCRIPTION OF REFERENCE NUMERALS

R1: absorption reactor
S1: CO₂ supply container
S2: CO₂ storage cylinder
P1: Pressure transducer for high pressure
PR1, PR2: Pressure regulator
T1, T2: Thermometer
V1 to V6: Valve
1: Stirrer

1. A carbon dioxide absorbent comprising: an oxygen-containing diamine represented by the following chemical formula 1, a cyclodiamine represented by the following chemical formula 2 and a polyalkylene glycol dialkyl ether represented by the following chemical formula 3: 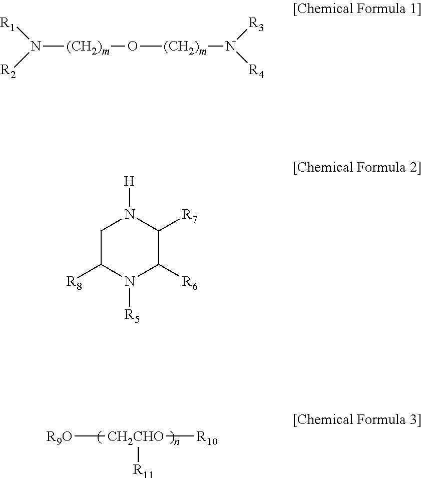
wherein,
R₁, R₂ and R₃ are each independently a C₁-C₄ alkyl group,
R₄ is hydrogen or a C₁-C₄ alkyl group,
R₅ is hydrogen, a C₁-C₄ alkyl group or a C₁-C₄ aminoalkyl group,
R₆ is hydrogen or a C₁-C₄ alkyl group,
R₇ and R₈ are each independently hydrogen or a C₁-C₄ alkyl group,
R₉ and R₁₀ are each independently a C₁-C₄ alkyl group,
R₁₁ is hydrogen or methyl,
m is an integer of 2 or 3, and
n is an integer of 2 to 4.

2. The carbon dioxide absorbent according to claim 1, wherein
R₁, R₂ and R₃ are each independently methyl, ethyl, propyl or butyl,
R₄ is hydrogen, methyl, ethyl, propyl or butyl,
R₅ is hydrogen, methyl, ethyl, propyl, butyl or aminoethyl,
R₆ is hydrogen or methyl,
R₇ and R₈ are each independently hydrogen or methyl, and
R₉ and R₁₀ are each independently methyl, ethyl, propyl or butyl.

3. The carbon dioxide absorbent according to claim 1, wherein the oxygen-containing diamine represented by the chemical formula 1 is selected from the group consisting of 2,2′-oxybis(N,N-dimethylethylamine) (BDMAE), 2,2′-oxybis(N,N-diethylethylamine)(BDEEA), 2,2′-oxybis(N,N-dipropylethylamine) (BDPEA), 2,2′-oxybis(N,N-dibutylethylamine) (BDBEA), 2,2′-oxybis(N,N-dimethylpropylamine) (BDMPA), 2,2′-oxybis(N,N-diethylpropylamine) (BDEPA), 2,2′-oxybis(N,N-dipropylpropylamine) (BDPPA), 2,2′-oxybis(N,N-dibutylpropylamine) (BDBPA), {2-[2-(dimethylamino)ethoxy]ethyl}methylamine (DMEEMA), {2-[2-(diethylamino)ethoxy]ethyl}ethylamine (DMEEEA), {2-[2-(diethylamino)ethoxy]ethyl}methylamine (DEEEMA), {2-[2-(dipropylamino)ethoxy]ethyl}propylamine (DPEEPA), {2-[2-(dibutylamino)ethoxy]ethyl}butylamine (DBEEBA), {3-[3-(dimethylamino)propoxy]propyl}methylamine (DMPPMA), {3-[3-(diethylamino)propoxy]propyl}ethylamine (DEPPEA), {3-[3-(diethylamino)propoxy]propyl}methylamine (DEPPMA), {2-[2-(dipropylamino)propoxy]propyl}propylamine (DPPPPA), and {2-[2-(dibutylamino)propoxy]propyl}butylamine (DBPPBA).

4. The carbon dioxide absorbent according to claim 1, wherein the cyclodiamine represented by the chemical formula 2 is selected from the group consisting of piperazine (PZ), 1-methylpiperazine (1-MPZ), 1-ethylpiperazine (1-EPZ), 1-propylpiperazine (1-PPZ), 1-isopropylpiperazine (1-IPPZ), 1-butylpiperazine (1-BPZ), 2-methylpiperazine (2-MPZ), 1,2-dimethylpiperazine (1,2-DMPZ), 1,5-dimethylpiperazine (1,5-DMPZ), 1,6-dimethylpiperazine (1,6-DMPZ), and N-(2-aminoethyl)piperazine (AEPZ).

5. The carbon dioxide absorbent according to claim 1, wherein the polyalkylene glycol dialkyl ether represented by the chemical formula 3 is selected from the group consisting of diethylene glycol dimethyl ether, diethylene glycol diethyl ether, diethylene glycol ethyl methyl ether, diethylene glycol dipropyl ether, diethylene glycol dibutyl ether, dipropylene glycol dimethyl ether, dipropylene glycol diethyl ether, dipropylene glycol ethyl methyl ether, dipropylene glycol dipropyl ether, dipropylene glycol dibutyl ether, triethylene glycol dimethyl ether, triethylene glycol diethyl ether, triethylene glycol dipropyl ether, triethylene glycol dibutyl ether, tripropylene glycol dimethyl ether, tripropylene glycol diethyl ether, tripropylene glycol dipropyl ether, tripropylene glycol dibutyl ether, tetraethylene glycol dimethyl ether, tetraethylene glycol diethyl ether, tetraethylene glycol ethyl methyl ether, tetraethylene glycol dipropyl ether, tetraethylene glycol dibutyl ether, tetrapropylene glycol dimethyl ether, tetrapropylene glycol diethyl ether, tetrapropylene glycol ethyl methyl ether, tetrapropylene glycol dipropyl ether, and tetrapropylene glycol dibutyl ether.

6. The carbon dioxide absorbent according to claim 1, wherein the amount of the oxygen-containing diamine is 10 to 70% by weight based on the total amount of the absorbent.

7. The carbon dioxide absorbent according to claim 1, wherein the amount of the cyclodiamine is 1 to 30% by weight based on the total amount of the absorbent.

8. The carbon dioxide absorbent according to claim 1, wherein the amount of the polyalkylene glycol dialkyl ether is 5 to 40% by weight based on the total amount of the absorbent.

9. The carbon dioxide absorbent according to claim 1, wherein the carbon dioxide absorbent is used by being dissolved in water.

10. The carbon dioxide absorbent according to claim 9, wherein the amount of water is 10 to 70% by weight based on the total amount of the absorbent.

11. A separation method of carbon dioxide from a gas mixture, which comprises the steps of:
(i) absorbing carbon dioxide by using the carbon dioxide absorbent according to claim 1; and
(ii) separating the absorbed carbon dioxide from the carbon dioxide absorbent.

12. The separation method according to claim 11, wherein the absorption temperature in step (i) is in the range of 10° C. to 60° C.

13. The separation method according to claim 11, wherein the absorption pressure in step (i) is in the range of normal pressure to 30 atm.

14. The separation method according to claim 11, wherein the separation temperature in step (ii) is in the range of 70° C. to 140° C.

15. The separation method according to claim 11, wherein the separation pressure in step (ii) is in the range of normal pressure to 2 atm.
